(19) United States
(12) Patent Application Publication
(10) Pub. No.: US 2004/0169646 A1
(43) Pub. Date: Sep. 2, 2004

(54) Three dimensional mapping of all-connect graph to create strong three dimensional structures

(76) Inventor: Bob Armstrong, New York, NY (US)

Correspondence Address: Bob Armstrong, 4B, 42 Peck Slip, New York, NY, 10038-1725, US

(21) Appl. No.: 10/690,107

(22) Filed: Oct. 21, 2003

Related U.S. Application Data
(60) Provisional application No. 60/419,860, filed on Oct. 21, 2002.

(51) Int. Cl. G06T 15/00

(52) U.S. Cl. 345/419

(57) ABSTRACT

A skeletal structure appropriate for the shell of very large very strong “skyscraping” life-spaces. Formed by pulling the center of a planar all-connect graph or mandala into cone, the very high symmetry of the resulting structure creates a shell of great beauty and strength. Large towers of square, hexagonal, or star-shaped, etc. cross-section can be created by dropping verticals from the planes of intersections in the grid-work of the shell.

### SUMMARY OF THE INVENTION

In 1979 the applicant solved the problem of finding minimal paths around n-dimensional cubes. In the process, he solved the problem for minimal paths around n-dimensional simplexes as well. A simplex is equivalently a graph on n+1 points connecting each point to every other. If these points are arranged around a circle, like the hours on a clock, the graph creates a figure of great symmetry, sometimes called a mandala. (See http://cosy.com/cosylogo.htm containing the paper “Euler Cycles and Pretty Pictures”, 1979.) At that time, the applicant created several large computer pen plotter images of mandalas of up to 50 points.

The applicant lives about a thousand meters from the site of the World Trade Center. In August 2002, when with the difficulties of the aftermath of their destruction, the applicant was having to downsize his living arrangements, requiring the careful moving and storage of the large 23-year-old 50-point computer plot. At that time, the competition for the design for a new World Center was putatively still open. These factors converged in the notion that grabbing the center of an all-connect mandala and pulling it out into a conical spire would make a beautiful, because of its enormous symmetry, and extremely strong shell appropriate for such a monumental life-space. It may be particularly attractive as the shell for a skyscraper in seismic zones. (See http://cosy.com/CoSy/ConicAllConnect/for in situ rendering.)

The applicant lives and works in an interactive programming environment in a very powerful computing language, and thus had the tools to solve the algorithms necessary to compute the list of beam lengths required to construct the structure itself, and the images included here.

### DETAILED DESCRIPTION

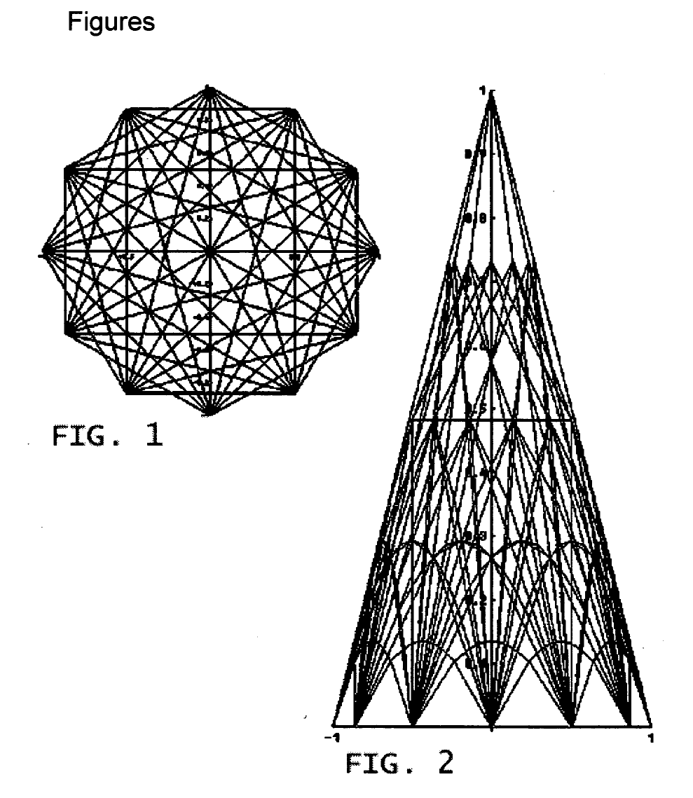

An “all-Connect” or “complete” graph on N points is a web formed by lines connecting each point to all others. Any all-connect graph is equivalent to a projection of an N−1 dimensional simplex onto two dimensions. When the N points are arranged evenly around a circle the graph is a figure of great symmetry (FIG. 1) which therefore distributes forces from any direction to all other points. When N is even, this includes radial elements crossing the center of the circle.

Mapping each vertex of the all-connect to a third dimension based on its distance from the center of the circle produces a conic structure inheriting these properties (FIG. 2).

This structure may form the outer skeleton of a building or enclosed space.

FIGS. 1 and 2 were produced by a computer algorithm generating a list of all line segments (beams) required to construct such a structure.

1. A skeletal structure constructed by:
1) a two dimensional projection, P of an N−1 dimensional simplex,
2) mapping the intersections of all line segments of P to 3 dimensions by a function Z[x;y].

2. A skeletal structure as claimed in 1 in which
1) the projection P maps the N vertices of the simplex evenly around a circle (assume centered at zero),
2) the function Z is a function of the distance of the intersection from zero. I.e.: Z is a function of (a*x\hat{ }2)+(b*y\hat{ }2).

3. A skeletal structure as in claim 2 with all-connect cross bracing at one or more level of beam intersections (which occur in planes).

4. A skeletal structure as in claim 3 truncated at such a plane.

5. A skeletal structure formed by stacking a structure as in claim 2 with one or more structures as in claim 3 or 4.

6. A skeletal structure as in claim 5 with vertical elements from its beam intersections to the base. These may form the corners and edges of walls of enclosed living space.
